(19) United States
(12) Patent Application Publication
(10) Pub. No.: US 2012/0112145 A1
(43) Pub. Date: May 10, 2012

(54) ELECTRIC CAPSTAN

(75) Inventor: Mingkui ZHENG, Ningbo City (CN)

(73) Assignee: NINGBO CHIMA WINCH CO., LTD., Ningbo City (CN)

(21) Appl. No.: 13/183,389

(22) Filed: Jul. 14, 2011

(30) Foreign Application Priority Data
Nov. 9, 2010 (CN) 201020612046.6
Jan. 20, 2011 (CN) 201120018108.5

(51) Int. Cl. B66D 1/14

(52) U.S. Cl. 254/342

(57) ABSTRACT

An electric capstan that supplies water, and which occupies less space and has a low cost. The electric capstan includes a motor, a reduction gear and a winching roller. The electric capstan further includes a water pump, and the input shaft of the water pump is connected to the output shaft of the motor.

### CROSS-REFERENCE(S) TO RELATED APPLICATION(S)

This application claims priority to Chinese Patent Application No. 201020612046.6, filed Nov. 9, 2010, and to Chinese Patent Application No. 201120018108.5, filed Jan. 20, 2011, each of which is hereby incorporated by reference in the present disclosure in its entirety.

### BACKGROUND

1. Field

The present disclosure relates generally to capstans, and more specifically to electric capstans.

2. Description of Related Art

Generally, an electric capstan in the related art includes a motor, a reduction gear and a winching roller, wherein the output shaft of the motor is connected to the reduction gear, and then the reduction gear is connected to the winching roller. Electric capstans are mainly used in off-road vehicle, agricultural vehicle, barge and other special vehicles, and are used as a self-protection device and a traction device for a vehicle or a ship. In the case of driving vehicles or ships for purpose of traction operation and rescue operation (including self-rescue operation), electric capstans act an important part.

However, in the practical purposes, in addition to the traction function, sometimes there is a need for being supplied with water. For example, especially, the off-road vehicle, the agricultural vehicle and the barge can be easily stained with feculency such as mud and thus pollute the vehicle body or ship body thereof, when they are operated in the wild or outdoors. Here, water is needed to flush the stained vehicle or ship. In order to solve above problem, a typical solution, at present, is to equip the vehicle or ship with a separate water pump. The equipment with a separated water pump may not only occupy the space inside the vehicles or ships, but also increase the weight and cost.

### BRIEF SUMMARY

One object of the present disclosure is to provide an electric capstan that is able to supply water and occupy less space, with a low cost.

In one embodiment, a goal of the present disclosure can be accomplished by following configuration. An electric capstan of the disclosure includes a motor, a reduction gear and a winching roller, and further includes a water pump, wherein the input shaft of the water pump is connected to the output shaft of the motor.

Compared with the related art, the present disclosure, with such above configuration, has following advantages. The electric capstan according to the present disclosure includes a water pump, wherein the input shaft of the water pump is connected to the output shaft of the motor. As a result, it is unnecessary to provide a separate water pump. Therefore, it is unnecessary to separately provide the motor, electric controller and cables of the water pump and provide a space to accommodate them. According to the present disclosure, the motor of the electric capstan is used for the power source of the water pump, and thus the present disclosure has advantages in water supplement, small size and reduced cost.

As a modification, the electric capstan according to the present disclosure further includes an engagement-disengagement gear, wherein the input shaft of the water pump is connected to or separated from the output shaft of the motor by the engagement-disengagement gear. As a result, this can allow the user to start or stop the water pump arbitrarily, so that the present disclosure has advantages in saving power and convenient use.

As a further modification, the engagement-disengagement gear includes a clutch and a lever that is able to engage or disengage the clutch, wherein the clutch has a groove, the lever at the end thereof has an eccentric and axial protrusion which can be embedded in the groove of the clutch, and the lever is rotatably attached to the housing of the clutch. This engagement-disengagement gear has a simple and reliable structure, high transmission efficiency and easy manipulation, which is advantageous to implement the electric capstan according to the present disclosure and improve the performance thereof.

As a further modification, the electric capstan according to the present disclosure further includes a transmission mechanism, the input end of which is connected to the output end of the motor, and the output end of which is located on the side face of motor and connected to the input shaft of the water pump. As a result, since the water pump is located on the sideface of the motor, the dimension of the electric capstan in the axial direction thereof can greatly reduce, that is the dimension of the electric capstan in the lengthwise direction thereof can greatly reduce, and therefore, the electric capstan according to the present disclosure has an advantage that it can be mounted on an object which provides a narrow mounting place.

As a further modification, the water pump is located above the sideface of the motor. As a result, this can make the whole structure of the electric capstan more compact and mounting of the water pump more convenient.

As a further modification, the transmission mechanism is a gear transmission mechanism. The gear transmission mechanism has stable and reliable transmission and high transmission efficiency, which can improve the performance of the electric capstan according to the present disclosure.

As a further modification, the gear transmission mechanism includes a bracket, a first gear, a second gear and a third gear, wherein the bracket is connected to the housing of the motor, the output shaft of the motor extends into the bracket, the housing of the water pump is connected with the bracket, and the input shaft of the water pump extends into the bracket; the connection of the input end of the transmission mechanism and the output shaft of motor means the connection of the first gear and the output shaft of motor; the second gear is mounted on the bracket; the connection of the output end of the transmission mechanism and the input shaft of the water pump means the connection of the third gear and the input shaft of the water pump; the first gear, the second gear and the third gear are engaged successively. As a result, since the three gears constitute the gear transmission mechanism, the electric capstan according to the present disclosure has a simple structure and reduced weight, and therefore, it is easy to be mounted on transportation such as a vehicle.

As a further modification, the engagement-disengagement gear is an engagement-disengagement handle that can be operated so as to move the second gear in the axial direction of the revolution shaft thereof and further engaged with or disengaged from the first gear, wherein the engagement-disengagement handle is mounted on the bracket, and the operational end of the engagement-disengagement handle is located on the side of the second gear. This engagement-disengagement gear has a simple and reliable structure, reduced cost and easy manipulation. Furthermore, the engagement-disengagement gear is arranged on the transmission mechanism, thus making the whole structure of the electric capstan more compact. This is advantageous to implement the electric capstan according to the present disclosure and improve the performance thereof.

### DESCRIPTION OF THE FIGURES

FIG. 1 is an exemplary structural view of the electric capstan according to the first embodiment of the present disclosure;

FIG. 2 is an exemplary cross-sectional view, in enlarged manner, showing the engagement-disengagement gear of the electric capstan according the first embodiment of to the present disclosure;

FIG. 3 is an exemplary structural view of the electric capstan according to the second embodiment of the present disclosure; and

FIG. 4 is another exemplary structural view of the electric capstan according to the second embodiment of the present disclosure.

In the figures, reference numeral 1 indicates a water pump, reference numeral 2 indicates a motor, reference numeral 3 indicates a winching roller, reference numeral 4 indicates a clutch, reference numeral 5 indicates a lever, reference numeral 6 indicates a bracket, reference numeral 7 indicates a first gear, reference numeral 8 indicates a second gear, reference numeral 9 indicates a third gear and reference numeral 10 indicates an engagement-disengagement handle.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

The details of the present disclosure are set forth in the accompanying drawings and the embodiments below.

### First Embodiment

In the first embodiment of the present disclosure, an electric capstan includes a motor 2, a reduction gear and a winching roller 3, and further includes a water pump 1. The input shaft of the water pump 1 is connected to the output shaft of the motor 2, the output shaft of the motor 2 is also connected to the reduction gear, and then the reduction gear is connected to the winching roller 3. The water pump 1, the motor 2, the reduction gear and the winching roller 3 are available from prior art, and thus the descriptions thereof are omitted.

The electric capstan further includes an engagement-disengagement gear, and the input shaft of the water pump 1 is connected to or disconnected from the output shaft of the motor 2 by the engagement-disengagement gear.

The engagement-disengagement gear includes a clutch 4 and a lever 5 that is able to engage or disengage the clutch 4. The clutch 4 has a groove, and the lever 5 at the end thereof has an eccentric and axial protrusion which can be embedded in the groove of the clutch. The lever 5 is rotatably attached to the housing of the clutch 4.

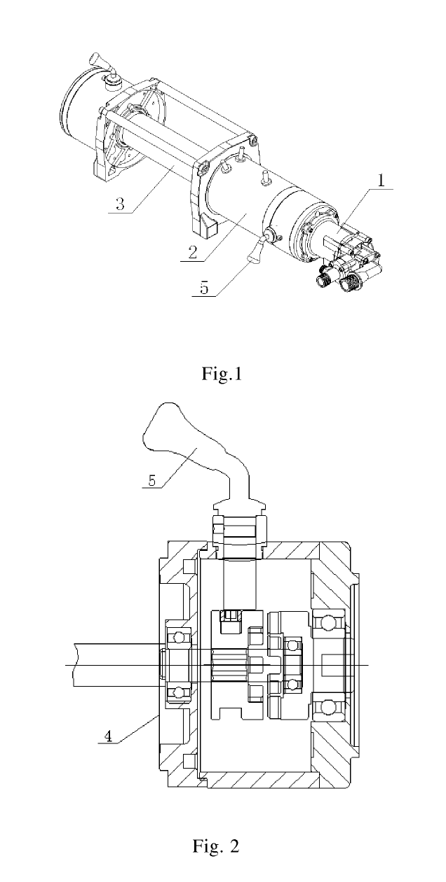

Such above configuration is shown in FIG. 1 or 2.

### Second Embodiment

In the second embodiment of the present disclosure, an electric capstan includes a motor 2, a reduction gear and a winching roller 3, and further includes a water pump 1. The input shaft of the water pump 1 is connected to the output shaft of the motor 2, the output shaft of the motor 2 is also connected to the reduction gear, and then the reduction gear is connected to the winching roller 3. The water pump 1, the motor 2, the reduction gear and the winching roller 3 are available from prior art, and thus the descriptions thereof are omitted.

The electric capstan further includes an engagement-disengagement gear, and the input shaft of the water pump 1 is connected to or disconnected from the output shaft of the motor 2 by the engagement-disengagement gear.

The electric capstan further includes a transmission mechanism, the input end of which is connected to the output shaft of the motor 2, and the output end of which is located on the side face of motor 2 and connected to the input shaft of the water pump 1.

The water pump 1 is located above the side face of motor 2, and the axis of the input shaft of the water pump 1 is in parallel with the axis of the output shaft of the motor 2.

The transmission mechanism is a gear transmission mechanism that includes a bracket 6, a first gear 7, a second gear 8 and a third gear 9. The bracket 6 is connected to the housing of the motor 2, the output shaft of the motor 2 extends into the bracket 6, the housing of the water pump 1 is connected with the bracket 6, and the input shaft of the water pump 1 extends into the bracket 6. The connection of the input end of the transmission mechanism and the output shaft of motor 2 means the connection of the first gear 7 and the output shaft of motor 2. The second gear 8 is mounted on the bracket 6. The connection of the output end of the transmission mechanism and the input shaft of the water pump 1 means the connection of the third gear 9 and input shaft of the water pump 1. The first gear 7, the second gear 8 and the third gear 9 are engaged successively.

The engagement-disengagement gear is an engagement-disengagement handle 10 that can be operated so as to move the second gear 8 in the axial direction of the revolution shaft thereof and further engaged with or disengaged from the first gear 7, wherein the engagement-disengagement handle 10 is mounted on the bracket 6, and the operational end of the engagement-disengagement handle 10 is located on the side of the second gear 8.

The water pump 1 may be provided with such a structure which contains detergent and the detergent may be supplied to water in the water pump 1. Thus, water pump 1 may be used as a washing machine, which is convenient for user.

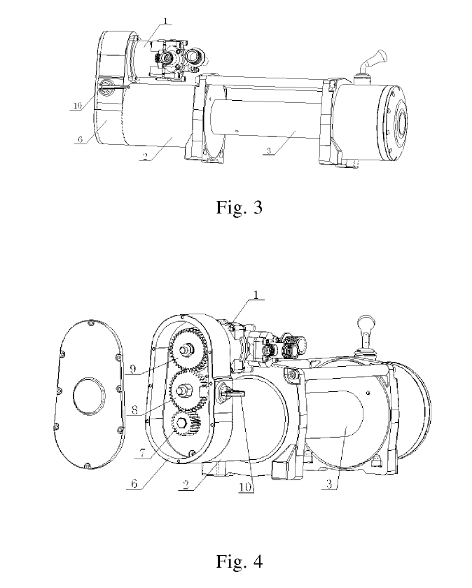

Such above configuration is shown in FIG. 3 or 4.

What is claimed is:

1. An electric capstan comprising:
a motor,
a reduction gear
a winching roller, and
a water pump,
wherein the input shaft of the water pump is connected to the output shaft of the motor.

2. The electric capstan according to claim 1, further comprising:
an engagement-disengagement gear,
wherein the input shaft of the water pump is connected to or disconnected from the output shaft of the motor by the engagement-disengagement gear.

3. The electric capstan according to claim 2, wherein:
the engagement-disengagement gear includes a clutch and a lever that is able to engage or disengage the clutch, wherein the clutch has a groove, the lever at the end thereof has an eccentric and axial protrusion which can be embedded in the groove of the clutch, and the lever is rotatably attached to the housing of the clutch.

4. The electric capstan according to claim 1, further comprising:
a transmission mechanism, the input end of which is connected to the output shaft of the motor, and the output end of which is located on the side face of motor and connected to the input shaft of the water pump.

5. The electric capstan according to claim 4, wherein:
the water pump is located above the sideface of the motor.

6. The electric capstan according to claim 4, wherein:
the transmission mechanism is a gear transmission mechanism.

7. The electric capstan according to claim 6, wherein:
the gear transmission mechanism includes a bracket, a first gear, a second gear and a third gear,
the bracket is connected to the housing of the motor, the output shaft of the motor extends into the bracket, the housing of the water pump is connected with the bracket, and the input shaft of the water pump extends into the bracket;
the connection of the input end of the transmission mechanism and the output shaft of motor means the connection of the first gear and the output shaft of motor;
the second gear is mounted on the bracket; the connection of the output end of the transmission mechanism and
the input shaft of the water pump means the connection of the third gear and input shaft of the water pump; and the first gear, the second gear and the third gear are engaged successively.

8. The electric capstan according to claim 2, wherein:
the engagement-disengagement gear is an engagement-disengagement handle that can be operated so as to move the second gear in the axial direction of the revolution shaft thereof and further engaged with or disengaged from the first gear, wherein the engagement-disengagement handle is mounted on the bracket, and the operational end of the engagement-disengagement handle is located on the side of the second gear.

9. The electric capstan according to claim 7, wherein:
the engagement-disengagement gear is an engagement-disengagement handle that can be operated so as to move the second gear in the axial direction of the revolution shaft thereof and further engaged with or disengaged from the first gear, wherein the engagement-disengagement handle is mounted on the bracket, and the operational end of the engagement-disengagement handle is located on the side of the second gear.
